(19) United States
(12) Patent Application Publication
(10) Pub. No.: US 2024/0093071 A1
(43) Pub. Date: Mar. 21, 2024

(54) A HOT MELT PRESSURE SENSITIVE ADHESIVE COMPOSITION

(71) Applicant: Avery Dennison Corporation, Mentor, OH (US)

(72) Inventors: Sangram K. SATPATHY, Pune (IN); Parimal NAIK, Pune (IN)

(21) Appl. No.: 18/260,944

(22) PCT Filed: Jan. 10, 2022
(86) PCT No.: PCT/US2022/011784

§ 371 Date: Jul. 11, 2023

(30) Foreign Application Priority Data
Jan. 11, 2021 (IN) 202111001202

(51) Int. Cl. C09J 153/02; C09J 7/38; G09F 3/10

(52) U.S. Cl. CPC C09J 153/02; C09J 7/387; G09F 3/10; C09J 2203/334; C09J 2453/00; G09F 2003/0241

(57) ABSTRACT

A hot melt pressure sensitive adhesive composition is provided comprising at least one thermoplastic block polymer, and at least one non-thermoplastic random polymer. The hot melt pressure sensitive adhesive composition of the present invention demonstrates improved processability and desirable adhesion performance for label applications. Further, the hot melt pressure sensitive adhesive composition is economical and environmentally sustainable.

### CROSS-REFERENCE TO RELATED APPLICATION

The present application claims the benefit of Indian Provisional Patent Application No. 202111001202 filed Jan. 11, 2021, which is incorporated herein by reference in its entirety.

### FIELD OF THE INVENTION

The present invention relates generally to a hot melt pressure sensitive adhesives (HMPSA) and in particular, to a hot melt pressure sensitive adhesives for label application.

### BACKGROUND OF THE INVENTION

Pressure-sensitive adhesives (PSA) have been used for a variety of applications such as labelling, packaging and other assembly purpose. Pressure-sensitive adhesives are materials which require no activation and adhere with no more than applied finger pressure are aggressive and permanently tacky at room temperature.

Typically, the pressure-sensitive adhesives (PSA) involves solution/solvent based adhesives, water/emulsion based adhesives, and hot-melt adhesives. The use of solvent based pressure sensitive adhesive is reduced, owing to their disadvantages including complex recycling of solvents, emission of solvents to the environment, workplace hazards due to highly flammable solvents. Similarly, use of the water based pressure sensitive adhesive is also associated with many drawbacks. The water based pressure sensitive adhesive requires removal of water, leading to energy intensive process. Evaporation of water also results in the uneven coating of the adhesive, and the restriction on coating speed imposed by the drying of the adhesive composition.

Therefore, solvent-free technologies for producing PSA are increasing in importance. Particularly, the hot melt pressure sensitive adhesives (HMPSA) are highly desirable, as the absence of solvent or water in the adhesive formulation lowers the energy required to form the adhesive layer and reduces the environmental problems associated with solvent-borne adhesives.

Hot melt pressure sensitive adhesives (HMPSA) are widely used for packaging applications, where high melt viscosities of HMPSA, leading to high adhesive strength is preferred. However, for labelling applications low melt viscosity, and quick stick performance are desirable features, and therefore, the use of hot melt pressure sensitive adhesives (HMPSA) for labelling applications require a different formulation approach.

There is, therefore, a need to provide an improved hot melt pressure sensitive adhesive composition that exhibit excellent adhesive performance in label applications and is economical.

### SUMMARY OF THE INVENTION

In one aspect of the present invention, a hot melt pressure sensitive adhesive composition (HMPSA) is described.

The hot melt pressure sensitive adhesive composition can comprise at least one thermoplastic block polymer in an amount in the range of 5 weight % to 50 weight % of the total weight of the adhesive composition; and at least one non-thermoplastic random polymer in an amount in the range of 5 weight % to 25 weight % of the total weight of the adhesive composition and optionally, at least one tackifier and at least one plasticizer.

The thermoplastic block polymer exhibits an A-B-A structure. The thermoplastic block polymer includes at least one of styrene-butadiene block polymer and styrene-isoprene block polymer. The thermoplastic block polymer is characterized by average di-block content in the range of 40% to 70% and a styrene monomer content in the range of 15% to 45%. The thermoplastic block polymer has solution viscosity in the range of 100 cps to 600 cps and a glass transition temperature in range of −80° C. to −50° C.

The non-thermoplastic random polymer exhibit exhibits A-B structure and includes emulsion polymerized styrene butadiene polymer. The non-thermoplastic random polymer has mooney viscosity in the range of 40 to 55 and a styrene monomer content in the range of 20% to 30%.

The hot melt pressure sensitive adhesive composition of the present invention demonstrates a static shear time to failure of greater than 300 minutes, measured at 23° C.; viscosity in the range from 10000 cps to 30000 cps, measured at 165° C.; glass transition temperature in the range of 0° C. to 10° C.; and elastic modulus (G′) of less than the Dahlquist criterion value of 3×10⁵ dynes/cm² at room temperature.

In another aspect of the present invention, a label that includes a hot melt pressure sensitive adhesive of the present invention is described. Typically, the label may include a substrate defining a first face and an oppositely directed second face; the hot melt pressure sensitive adhesive composition of the present invention disposed on the first face of the substrate; and optionally, a release liner at least partially covering the adhesive disposed on the substrate.

In still another aspect of the present invention, a labelled article is described. A labelled article may comprise an article defining an outer surface; and a pressure sensitive label of the present invention being attached to the article along the outer surface of the article.

### DETAILED DESCRIPTION OF THE INVENTION

The present invention envisages a hot melt pressure sensitive adhesive composition (HMPSA) that provide improved processing advantages, desirable adhesion performance characteristics, and is economical. The hot melt pressure sensitive adhesive composition (HMPSA) of the present invention exhibit adhesion to different substrates such as cardboards and plastics, with excellent adhesion properties.

As noted herein, several hot melt pressure sensitive adhesives (HMPSAs) are known. Conventionally, the hot melt pressure sensitive adhesives incorporate the solution polymerized polymer as the backbone of the adhesive composition. The solution polymerized thermoplastic polymers are expensive materials, leading to increased cost of HMPSA production.

Further, it was observed that the incorporation of the emulsion polymerized non-thermoplastic polymer leads to very high melt viscosity of the adhesive composition. Increase in the viscosity of the adhesive composition can be attributed to the absence of definite blocks and random microstructure between co-monomers of the emulsion polymerized non-thermoplastic polymer, along with its wide molecular weight distribution

If the viscosity of the HMPSA is too high, then the processability of the adhesive becomes challenging. High viscosities of the adhesive composition leads to poor melt flow of the adhesive composition, which further results in uneven coating of the HMPSA, as well as reduced coating rate. In particular, an HMPSA with a higher viscosity can be more difficult to use in standard compounding and coating processes associated with the adhesive label production, wherein low melt viscosity coating, quick stick performance are desirable features.

Without being bound by theory, it is now surprisingly found that the specific combination of a non-thermoplastic random polymer with one or more specifically selected thermoplastic block polymers, provides for an HMPSA with improved processability and adhesion characteristics desired for label application.

In an embodiment of the present invention, the hot melt pressure sensitive adhesive composition can comprise at least one non-thermoplastic random polymer; at least one thermoplastic block polymer; and optionally at least one tackifier; and optionally at least one plasticizer.

The non-thermoplastic random polymer of the present invention exhibit A-B structure. Typically, the non-thermoplastic random polymer is an emulsion polymerized styrene-butadiene polymer. The non-thermoplastic random polymer has mooney viscosity in the range of 40 to 55 and a styrene monomer content in the range of 20% to 30%.

Mooney viscosity of polymers is a measure of molecular weight and entanglement of polymer chain. Higher Mooney viscosity indicates higher entanglement and higher molecular weight of the polymer, which will impart increase in viscosity to the adhesive composition. Accordingly, the non-thermoplastic polymers with lower mooney viscosities help to achieve desired melt flow and viscosity of the adhesive composition required for label application.

The amount of the non-thermoplastic random polymer can be in the range of 5 weight % to 25 weight % of the total weight of the adhesive composition. In terms of upper limits, the non-thermoplastic polymer can be less than 25 weight %, less than 20 weight %, or less than 15 weight % of the total weight of the adhesive composition. In terms of lower limits, non-thermoplastic polymer can be at least 5 weight %, at least 10 weight % of the total weight of the adhesive composition.

Typically, the thermoplastic block polymer exhibits an A-B-A structure. The thermoplastic block polymer can include, but is not limited to at least one of styrene-butadiene block polymer and styrene-isoprene block polymer. In accordance with the embodiments of the present invention, the thermoplastic block polymer has solution viscosity in the range of 100 cps to 600 cps and a glass transition temperature in range of −80° C. to −50° C.

The amount of the thermoplastic block polymer can be in the range of 5 weight % to 50 weight % of the total weight of the adhesive composition. Typically, the amount of the thermoplastic polymer can be in the range of 10 weight % to 30 weight % of the total weight of the adhesive composition.

The thermoplastic polymer may have average di-block content in the range of 40% to 70%. It has been found that higher di-block content may be associated with an increase in tack and a lower di-block content may be associated with an increase in elasticity of the copolymer. In terms of upper limits, the di-block content can be less than 70 weight %, less than 65 weight %, less than 60 weight %, less than 55 weight %, less than 50 weight %. In terms of lower limits, the di-block content can be at least 40 weight %, at least 45 weight %, at least 50 weight %.

In one embodiment, the thermoplastic block polymer can be styrene-butadiene block polymer characterized by the di-block content in the range of 50% to 70%.

In another embodiment, the thermoplastic polymer can be styrene-isoprene block polymer characterized by the di-block content in the range of 40% to 60%.

The styrene monomer content of the thermoplastic block copolymer can impact the performance characteristics of the thermoplastic block copolymer. It has been found that a specific styrene content, along with a specific di-block content, can give an adhesive composition with the desired properties of melt flow and viscosity. Together these properties make the polymer more suitable for compounding and coating processes.

In accordance with the embodiments of the present invention, the styrene monomer content of the thermoplastic block polymer can be in the range of 15% to 45%, e.g., from 15 to 25 weight %, from 20 to 35 weight %, from 25 to 45 weight %. In terms of upper limits, the styrene content can be less than 45 weight %, or less than 40 weight %, or less than 35 weight %. In terms of lower limits, the styrene content can be at least 15 weight %, at least 20 weight %, or at least 25 weight %.

Optionally, the hot melt pressure sensitive adhesive composition can comprise at least one tackifier resin. Tackifiers provide tack and adhesion qualities to the adhesive. They are lower molecular weight polymers with high glass transition (Tg) temperatures, generally above room temperature.

There are three broad classes of tackifiers: rosin esters, hydrocarbon resins, and terpene resins. Terpene resins are derived from wood or citrus. They are very versatile but are expensive due to limited supply. Rosin esters are derived from tree stumps (wood rosin), sap (gum rosin) or are by-products of the paper making process (tall oil rosin). Hydrocarbon resins are made from petroleum feedstocks and are either aliphatic or aromatic (containing ringed compounds like styrene).

The key criteria for tackifier selection is compatibility with the rubber component. Other factors that must be considered include stability, color, softening point, and odor. Many tackifiers are distinct brown or yellow colors. They can be processed to be clear; this adds expense to the product.

The tackifying resin(s) which are employed in the hot melt construction adhesives of the present invention are those which extend the adhesive properties and improve specific adhesion characteristics of the adhesives.

As used herein, the term “tackifying resin” includes, but is not limited to, natural and modified rosins such as gum rosin, wood rosin, tall-oil rosin, distilled rosin, hydrogenated rosin, dimerized rosin and polymerized rosin; glycerol and pentaerythritol esters of natural and modified rosins, such as the glycerolesters of pale wood rosin, polymerized rosin and the pentaerythritol ester of pale wood rosin, phenolic-modified pentaerythritol ester of rosin; polyterpene resins having a softening point, as determined by ASTM method E28-58T, of from about 60° C. to about 140° C. The latter polyterpene resins generally resulting from the polymerization of terpene hydrocarbons, such as mono-terpene known as pinene, in the presence of Friedel-Crafts catalysts at moderately low temperatures; also included are the hydrogenated polyterpene resins; copolymers and terpolymers of natural terpenes, e.g., styrene terpene, a-methyl styrene/terpene and vinyl toluene, terpene; phenolic-modified terpene resins such as, for example, the resin product resulting from the condensation, in an acidic medium, of a terpene and a phenol; aliphatic petroleum hydrocarbon resins having Ball and Ring softening points of from about 60° C. to 140° C., the latter resins resulting from the polymerization of monomers consisting primarily of olefins and diolefins; also included are the hydrogenated aliphatic petroleum hydrocarbon resins; aromatic petroleum hydrocarbons and the hydrogenated derivatives thereof, aliphatic-/aromatic petroleum derived hydrocarbons and the hydrogenated derivatives thereof.

The preferred tackifying resins for the present invention are tall-oil rosin having softening points from about 60° C. to about 130° C.

In accordance with one embodiment of the present invention, the tackifier is characterized with a softening point near about 80° C. to 110° C. and acid value in the range of 10 to 20.

The amount of the tackifier resin can be in the range of 40 weight % to 65 weight % of the total weight of the adhesive composition. In terms of upper limits, the amount of the tackifier resin can be less than 65 weight %, less than 60 weight %, and less than 55 weight % of the total weight of the adhesive composition. In terms of lower limits, amount of the tackifier resin can be at least 40 weight % or at least 45 weight % of the total weight of the adhesive composition.

Optionally, the hot melt pressure sensitive adhesive composition can comprise at least one plasticizer. As their name implies, they are used to facilitate easy processing of the adhesive, reducing viscosity of the molten formula. In addition to supporting the manufacturing process, they help in wet out on surfaces as well as cold temperature resistance by lowering the glass transition temperature, Tg. The plasticizer reduces peel values, viscosities and storage modulus of the adhesive composition, thus increasing flexibility.

Care must be taken when using these plasticizer oils to ensure they are truly compatible with the other components. Over time they will separate from the formula, migrating to the surface. In end use, this results in oil blotches referred to as staining.

The plasticizer can include, but is not limited to at least one of petroleum oil, phthalate and adipate esters, oligomers of polypropylene, polybutenes, polyisoprene, hydrogenated polyisoprene and polybutadiene, benzoate esters, and Vegetable and animal oils and derivatives thereof and mixtures of two or more of the foregoing.

The inventors have also discovered that with the increase in aromatic carbon % of in the plasticizer, the melt viscosity of the adhesive becomes very high, typically falling in the range 50000 cps to 80000 cps at 165° C. Therefore, in order to keep the melt viscosity low without sacrificing the polymer percentage, a low viscosity and low aromatic carbon content plasticizer oil is more suitable.

In accordance with one embodiment of the present invention, the plasticizer demonstrates kinematic viscosity @ 40° C. in the range of 20 to 80 cSt and aromatic carbon % in the range of 0 to 15. The plasticizer demonstrates flash points greater than 200° C. and pour point no less than −33° C.

The amount of the plasticizer is in the range of 5 weight % to 25 weight % of the total weight of the adhesive composition, e.g. from 5 weight % to 15 weight %, from 10 weight % to 20 weight %, from 15 weight % to 25 weight %.

The hot melt pressure sensitive adhesive composition can further include at least one wax selected from the group consisting of paraffin wax, a microcrystalline wax, Fischer-TropSch wax, polyethylene wax, and an oxidized polyethylene wax. The amount of wax can be in the range of 0.0 weight % to 10.0 weight % of the total weight of the adhesive composition.

Wax is incorporated in the HMPSA composition with the aim of reducing the melt viscosity within a smooth coatable limit without reducing the polymer content in the composition so as to achieve the desired adhesion and shear strength. The inventors, however, found that with FT waxes, the melt viscosity is reduced but the coating dries very fast before lamination owing to reduced anchor to the face paper. Besides the adhesion and shear strength also reduces. Therefore, it is important to tune the specific amount of the wax so as to achieve reduction in melt viscosity without affecting drying time, and shear strength.

In accordance with the embodiment of the present invention, FT waxes having MW in the range 750 to 2500 daltons and congealing point 80° C. to 115° C. can be used. These waxes help in improving the melt viscosity but adversely affect the coating process.

The hot melt pressure sensitive adhesive composition can further include at least one filler selected from any of lime stone, calcium carbonate, talc, clay, barium sulphate and calcium sulphate. The amount of filler can be in the range of 0.0 weight % to 20.0 weight % of the total weight of the adhesive composition.

The hot melt pressure sensitive adhesive composition can further include a stabilizer selected from a phenol compound and a phosphite compound. The amount of stabilizer can be in the range of 0.0 weight % to 10.0 weight % of the total weight of the adhesive composition.

The hot melt pressure sensitive adhesive of the present invention demonstrates a static shear time to failure of greater than 300 minutes, measured at 23° C., and viscosity in the range from 10000 cps to 30000 cps, measured at 165° C.

The present invention further relates to labels that include a hot melt pressure sensitive adhesive composition of the present invention. In accordance with the present invention the label can comprise a substrate/facestock defining a first face and an oppositely directed second face; the adhesive composition disposed on the first face of the substrate; and optionally, a release liner at least partially covering the adhesive disposed on the substrate. The labels can also include one or more facestock layers, one or more optional print layers.

A wide variety of facestocks can be used with the adhesive to manufacture adhesive articles such as labels. The facestock material can include paper and polymeric film materials such as polyolefins (e.g., polyethylene, polypropylene, ethylene-propylene copolymers, etc.). Paper material can be C1S or C2S semi-gloss or high gloss paper or art paper or direct thermal or thermal transfer papers. The facestock can be a monolayer material or a multilayer construction. The facestock may comprise a flexible facestock or a transparent polymeric film.

Typically, the adhesive composition is disposed of on the first face of the substrate, and the adhesive layer has a thickness within a range of from 5 gsm to 30 gsm.

The HMPSA layer can be applied directly adjacent to, and in contact with, the facestock. There can be intervening layers between the HMPSA layer and the facestock. The label can include two or more layers of HMPSA and/or facestock. The HMPSA layer of the label can be coated onto the facestock with a coat weight of, for example, from 5 grams per square meter (gsm) to 30 gsm. The adhesive layer coat weight can be from 6 gsm to 20 gsm, from 8 gsm to 20 gsm, from 22 gsm to 30 gsm, from 16 gsm to 40 gsm. In some embodiments, the adhesive layer coat weight is within the range from 5 gsm to 40 gsm. In terms of upper limits, the adhesive layer coat weight can be less than 40 gsm, e.g., less than 35 gsm, less than 30 gsm, less than 25 gsm, less than 20 gsm, less than 15 gsm, or less than 10 gsm. In terms of lower limits, the adhesive layer coat weight can be at least 5 gsm, e.g., at least 10 gsm, at least 15 gsm, at least 20 gsm, at least 25 gsm, or at least 30 gsm.

The present invention also relates to a labelled article that includes a hot melt pressure sensitive adhesive of the present invention. The labelled article can comprise an article defining an outer surface; and the pressure sensitive label of the present invention attached to the article along the outer surface of the article.

The outer surface to which the HMPSA is adhered can include a wide range of substrates. The outer surface can include glass, plastic, wood, and metal, combination of these, and other materials.

In some embodiments, the outer surface of the container includes plastic. The outer surface can include or be formed from any suitable polymer or mixture of polymers. The polymer or mixture of polymers can include, for example, PET, recycled polyethylene terephthalate (rPET), high density polyethylene (HDPE), polyvinyl chloride (PVC), poly lactic acid (PLA), cellulose, biopolymer films, low density polyethylene (LDPE), PP, polystyrene (PS), polyesters, or other types of polymers or plastics.

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

Table 1 represents different formulations (Example 1 to Example 6) involving emulsion polymerized non-thermoplastic polymer and relative proportions of other ingredients such as tackifier, plasticizer and stabilizer. Absence is represented as ( - - - ).

TABLE 1

| | | | | | | |
|---|---|---|---|---|---|---|
| | Example | Example | Example | Example | Example | Example |
| | 1 | 2 | 3 | 4 | 5 | 6 |
| Ingredients/Raw Material | Mix 1 | Mix 2 | Mix 3 | Mix 4 | Mix 5 | Mix 6 |

Adhesive Composition (%)

| | | | | | | |
|---|---|---|---|---|---|---|
| Non-thermoplastic random | 10-25 | 5-15 | 5-15 | 5-15 | 5-15 | 5-15 |
| polymer | | | | | | |
| (emulsion polymerized | | | | | | |
| styrene block polymer) | | | | | | |
| Thermoplastic block polymer | 20-35 | 5-20 | 5-20 | 5-20 | - - - | - - - |
| (SIS block copolymer) sty | | | | | | |
| Thermoplastic block polymer | - - - | - - - | - - - | - - - | 5-20 | - - - |
| (SIS block polymer with low | | | | | | |
| di-block content) | | | | | | |
| Thermoplastic block polymer | - - - | - - - | - - - | - - - | - - - | 10-20 |
| (SBS block copolymer) | | | | | | |
| Plasticizer | 5-30 | 10-30 | 10-20 | | 10-20 | 10-20 |
| Plasticizer- (low viscosity oil) | - - - | - - - | - - - | 10-20 | - - - | - - - |
| Tackifier | 30-60 | 30-60 | 30-60 | 30-60 | 30-60 | 30-60 |
| Stabilizer | 0.5-2 | 0.5-2 | 0.5-2 | 0.5-2 | 0.5-2 | 0.5-2 |
| Wax | 1-5 | 1-5 | - - - | 1-5 | 1-5 | 1-5 |
| synthetic wax | - - - | - - - | 1-8 | - - - | - - - | - - - |

Performance Characteristics

| | | | | | | |
|---|---|---|---|---|---|---|
| Melt viscosity | 50000- | 15000- | 15000- | 15000- | 25000- | 10000- |
| (cps) | 800000 | 30000 | 30000 | 60000 | 60000 | 30000 |
| Processability | Poor | Good | Good | Medium | Poor | Good |
| Adhesion Performance | Poor | Good | Poor | Good | poor | Good |
| Shear Performance | Poor | Poor | Poor | Poor | poor | Good |

Examples 1 to 4 from table 1 incorporates SIS bock polymer characterized with less than 20% styrene monomer content and more than 50% di-block content. Examples 5 incorporates SIS bock polymer characterized with less than 20% styrene monomer content and less than 40% di-block content. Example 6 SBS bock polymer characterized with more than 20% styrene monomer content and more than 50% di-block content. Further, examples 1-3 and 5-6 incorporate plasticizer with low aromatic content, whereas example 4 includes plasticizer with high aromatic content.

From Table 1, it is observed that higher amounts of the emulsion polymerized non-thermoplastic copolymer leads to increased viscosity and poor processability. The high molecular weight distribution of the emulsion polymerized non-thermoplastic copolymer can be considered accountable for increased viscosity of the adhesive composition. Further, low di-block content in the emulsion polymerized non-thermoplastic copolymer increases viscosity of the adhesive composition, resulting in poor processability of the adhesive composition. Furthermore, high aromatic content of the plasticizer oil increases the viscosity of the adhesive composition.

Labels were prepared using the HMPSA of Example 6 with different facestocks. The labels were tested for desired adhesion and shear strength required for label application.

TABLE 2

| Description | | | Mix | Mix |
|---|---|---|---|---|
| Test | Unit | Method | 6-C1S | 6-C2S |
| Loop tack-HDPE -RT | Max | FTM 9 | 14.04 | 16.03 |
| Loop tack-SS -RT | load at | | 24 | 20.71 |
| Loop tack-glass -RT | N/25 mm | | 22.25 | 19.31 |
| 90 peel-20 min-HDPE -RT | Avg | FTM 2 | 4.95/FS | 6.52/FS |
| 90 peel-20 min-SS -RT | load at | | 4.08/FS | 6.11/FS |
| 90 peel-24 hrs-HDPE -RT | N/25 mm | | 2.27/FS | 12.43/FS |
| 90 peel-24 hrs-SS -RT | | | 2.66/FS | 11.23/AT |
| | | | | (100%) |
| Static shear | Minutes | FTM 8 | 286.5 | 315 |

Overall it is observed that hot melt pressure sensitive adhesive composition with specific combination of non-thermoplastic polymer characterized with low mooney viscosity, thermoplastic polymer with higher styrene content and higher di-block content along with plasticizer oil with low viscosity and low aromatic carbon content leads to a suitable adhesive composition with coatable melt viscosity, desired adhesion and shear strength required for label application.

Typical Performance Data provided in the present disclosure only serves as reference to product performance under specified testing conditions and does not represent a specification.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

1. A hot melt pressure sensitive adhesive composition, comprising:
at least one thermoplastic block polymer; and
at least one non-thermoplastic random polymer.

2. The hot melt pressure sensitive adhesive composition as claimed in claim 1, wherein the amount of said thermoplastic block polymer is in the range of 5 weight % to 50 weight % of the total weight of the adhesive composition.

3. The hot melt pressure sensitive adhesive composition of claim 1, wherein said thermoplastic block polymer exhibits an A-B-A structure.

4. The hot melt pressure sensitive adhesive composition of claim 1, wherein said thermoplastic block polymer includes at least one of styrene-butadiene block polymer and styrene-isoprene block polymer.

5. The hot melt pressure sensitive adhesive composition of claim 1, wherein said thermoplastic block polymer has average di-block content in the range of 40% to 70% and a styrene monomer content in the range of 15% to 45%.

6. The hot melt pressure sensitive adhesive composition of claim 1, wherein said thermoplastic block polymer has a solution viscosity in the range of 100 cps to 600 cps and a glass transition temperature in the range of −80° C. to −50° C.

7. The hot melt pressure sensitive adhesive composition of claim 1, wherein the amount of said non-thermoplastic random polymer is in the range of 5 weight % to 25 weight % of the total weight of the adhesive composition.

8. The hot melt pressure sensitive adhesive composition of claim 1, wherein the non-thermoplastic random polymer exhibits an A-B structure.

9. The hot melt pressure sensitive adhesive composition of claim 1, wherein said non-thermoplastic random polymer includes an emulsion polymerized styrene butadiene polymer.

10. The hot melt pressure sensitive adhesive composition of claim 1, wherein said non-thermoplastic random polymer has mooney viscosity in the range of 40 to 55 and a styrene monomer content in the range of 20% to 30%.

11. The hot melt pressure sensitive adhesive composition of claim 1, further comprising at least one tackifier.

12. The hot melt pressure sensitive adhesive composition as claimed in claim 11, wherein the amount of said tackifier resin is in the range of 40 weight % to 65 weight % of the total weight of the adhesive composition.

13. The hot melt pressure sensitive adhesive composition as claimed in claim 11, wherein said tackifier resin has an average molecular weight 350 to 2000 g/mol and a softening point in the range of 85° C. to 105° C.

14. The hot melt pressure sensitive adhesive composition as claimed in claim 11, wherein said tackifier resin includes at least one of rosin esters, hydrocarbon resins, and terpene resins.

15. The hot melt pressure sensitive adhesive composition as claimed in claim 1, further comprising at least one plasticizer.

16. The hot melt pressure sensitive adhesive composition as claimed in claim 15, wherein the amount of said plasticizer is in the range of 5 weight % to 45 weight % of the total weight of the adhesive composition.

17. The hot melt pressure sensitive adhesive composition as claimed in claim 15, wherein said plasticizer has a solution viscosity in the range of 60 to 90 cSt at 40° C. and an aniline point in the range of 98° C. to 130° C.

18. The hot melt pressure sensitive adhesive composition as claimed in claim 15, wherein said plasticizer includes at least one of petroleum oil, phthalate and adipate esters, oligomers of polypropylene, polybutenes, polyisoprene, hydrogenated polyisoprene and polybutadiene, benzoate esters, vegetable oils, animal oils, derivatives thereof and mixtures thereof.

19. The hot melt pressure sensitive adhesive composition as claimed in claim 1, further comprising at least one wax in an amount in the range of 0.0 weight % to 10.0 weight % of the total weight of the adhesive composition.

20. The hot melt pressure sensitive adhesive composition of claim 19, wherein said wax includes at least one of a paraffin wax, a microcrystalline wax, a Fischer-Tropsch wax, a polyethylene wax, and an oxidized polyethylene wax.

21. The hot melt pressure sensitive adhesive composition as claimed in claim 1, further comprising at least one filler in an amount in the range of 0.0 weight % to 20.0 weight % of the total weight of the adhesive composition.

22. The hot melt pressure sensitive adhesive composition of claim 21, wherein said filler includes at least one of lime stone, calcium carbonate, talc, clay, barium sulphate and calcium sulphate.

23. The hot melt pressure sensitive adhesive composition of claim 1, further comprising at least one stabilizer in an amount in the range of 0.0 weight % to 10.0 weight % of the total weight of the adhesive composition.

24. The hot melt pressure sensitive adhesive composition of claim 23, wherein said stabilizer includes at least one of a phenol compound and a phosphite compound.

25. The hot melt pressure sensitive adhesive composition as claimed in claim 1, wherein the adhesive composition demonstrates:
i. a static shear time to failure of greater than 300 minutes, measured at 23° C.;
ii. a viscosity in the range from 10000 cps to 30000 cps, measured at 165° C.;
iii. a glass transition temperature in the range of 0° C. to 10° C.; and
iv. an elastic modulus (G′) of less than the Dahlquist criterion value of 3×10⁵ dynes/cm² at room temperature.

26. A label comprising:
i. a substrate defining a first face and an oppositely directed second face;
the adhesive composition of any of the preceding claims disposed on the first face of the film; and
optionally, a release liner at least partially covering the adhesive disposed of on the film.

27. The label as claimed in claim 26, wherein the adhesive composition is disposed on the first face of the substrate, and the layer has a thickness within a range of from 5 gsm to 30 gsm.

28. A labelled article comprising:
i. an article defining an outer surface; and
ii. a label of any of the preceding claims being attached to the article along the outer surface of the article.

29. The labelled article of claim 28, wherein the outer surface of article comprises at least one of a glass, plastic, wood, metal, and a combination thereof.
